(19) United States
(12) Patent Application Publication
(10) Pub. No.: US 2026/0229544 A1
(43) Pub. Date: Aug. 6, 2026

(54) ELECTRODE FOR AN ALL-SOLID-STATE BATTERY AND AN ANODELESS BATTERY INCLUDING THE SAME

(71) Applicants: HYUNDAI MOTOR COMPANY, Seoul (KR); KIA CORPORATION, Seoul (KR); Research & Business Foundation SUNGKYUNKWAN UNIVERSITY, Suwon-si (KR)

(72) Inventors: Ki Yoon Bae, Hwaseong-si (KR); Ji Young Kim, Hwaseong-si (KR); Jong Chan Song, Hwaseong-si (KR); Sang Heon Lee, Hwaseong-si (KR); Sam Ick Son, Hwaseong-si (KR); Sun Hyeong Kwon, Suwon-si (KR); Byung Gon Song, Suwon-si (KR); Dong Hyoung Kim, Suwon-si (KR); Woo Hyeong Sim, Suwon-si (KR); Hyung Mo Jeong, Suwon-si (KR)

(73) Assignees: HYUNDAI MOTOR COMPANY, Seoul (KR); KIA CORPORATION, Seoul (KR); Research & Business Foundation SUNGKYUNKWAN UNIVERSITY, Suwon-si (KR)

(21) Appl. No.: 19/311,683

(22) Filed: Aug. 27, 2025

(30) Foreign Application Priority Data
Feb. 5, 2025 (KR) 10-2025-0014791

(51) Int. Cl. H01M 4/66; H01M 4/02; H01M 4/133; H01M 4/1393; H01M 10/0562; H01M 10/0585

(52) U.S. Cl. CPC H01M 4/667; H01M 4/133; H01M 4/1393; H01M 4/663; H01M 10/0562; H01M 10/0585; H01M 2004/021; H01M 2004/027; H01M 2300/008

(57) ABSTRACT

An electrode for an all-solid-state battery includes at least a current collector, and an intermediate layer including a carbon structure and disposed on the current collector. The carbon structure includes a plurality of base bodies arranged with separation spaces formed between adjacent base bodies among the plurality of base bodies, and the separation spaces include a lithium deposition separation space having a width ranging from 0.3 nm to 10 nm. The diameter (D₅₀) corresponding to 50% of a cumulative volume in a cumulative volume distribution ranges from 5 μm to 12 μm.

### CROSS-REFERENCE TO RELATED APPLICATION

This application claims priority to Korean Patent Application No. 10-2025-0014791, filed in the Korean Intellectual Property Office on Feb. 5, 2025, the entire contents of which are incorporated herein by reference.

### FIELD

The present disclosure relates to an all-solid-state battery including an intermediate layer to precipitate lithium and an anodeless battery including the same.

### BACKGROUND

A secondary battery, which is rechargeable, has been used not only in a smaller electronic device, such as a cellular phone or a laptop computer, but also in a larger transportation, such as a hybrid vehicle or an electric vehicle. Accordingly, there is a need to develop a secondary battery having higher stability and energy density.

For a conventional secondary battery, a cell is mainly formed based on an organic solvent (or an organic liquid electrolyte). Accordingly, the conventional secondary battery has a limitation in improving stability and an energy density. An allsolid-state battery employing an inorganic solid electrolyte is based on a technology without the organic solvent. Accordingly, the all-solid-state battery has been spotlighted, as a cell may be manufactured in a stabler and simpler form.

The all-solid-state battery includes a cathode active material layer bonded to a cathode current collector, an anode active material layer bonded to an anode current collector, and a solid electrolyte layer interposed between the anode active material layer and the cathode active material layer. However, the anode active material layer includes a solid electrolyte for moving lithium ions in addition to the anode active material, such as graphite, and the solid electrolyte has a specific gravity higher than a specific gravity of a liquid electrolyte. Accordingly, an energy density of the all-solid-state battery is lower than an energy density of a lithium ion battery using the liquid electrolyte.

To increase the energy density of the all-solid-state battery, studies and researches have been actively performed on an anodeless all-solid-state battery in a storage type to directly precipitate lithium ions on the anode current collector in the form of lithium metal, without the anode active material layer.

A conventional anodeless all-solid-state battery includes an intermediate layer interposed between the solid electrolyte layer and the anode current collector, including silver (Ag) and a carbon material to uniformly precipitate and deposit lithium. When charging the anodeless all-solid-state battery, lithium ions (Lit) of the cathode reach the intermediate layer through the solid electrolyte layer. After making an alloy reaction with silver (Ag), the lithium ions (Lit) are moved and precipitated between the anode current collector and the intermediate layer.

However, in the anodeless all-solid-state battery, the uncontrolled lithium dendrite growth and the side reactions consume active lithium and cause internal short circuits, thereby shortening the lifespan of the anodeless all-solid-state battery.

### SUMMARY

The present disclosure is directed to improving performance and stability in battery systems, while retaining certain advantageous characteristics of conventional designs.

An aspect of the present disclosure provides an electrode for an anodeless all-solid-state battery, which is capable of preventing lithium dendrite growth, and preventing lithium from making direct contact with a solid electrolyte.

Another aspect of the present disclosure provides an anodeless all-solid-state battery which includes an electrode for the anodeless all-solid-state battery to prevent lithium dendrite growth and to prevent lithium from making direct contact with a solid electrolyte, thereby exhibiting an excellent lifespan characteristic and an excellent battery characteristic.

The technical problems to be solved by the present disclosure are not limited to the aforementioned problems, and any other technical problems not mentioned herein should be clearly understood from the following description by those having ordinary skill in the art to which the present disclosure pertains.

The present disclosure provides an electrode for an all-solid-state battery, which includes a current collector, and an intermediate layer that includes a carbon structure and is disposed on the current collector. The carbon structure includes a plurality of base bodies arranged with separation spaces formed between adjacent base bodies among the plurality of base bodies. In particular, the separation space includes a lithium deposition separation space including a width ranging from 0.3 nm to 10 nm. The diameter (D₅₀) corresponding to 50% of the cumulative volume in a cumulative volume distribution of a base body of the plurality of base bodies ranges from 5 μm to 12 μm.

The present disclosure provides an electrode for an all-solid-state battery, in which a diameter (D₁₀) corresponding to 10% of the cumulative volume in the cumulative volume distribution of the base body ranges from 1.5 μm to 4.5 μm.

The present disclosure provides an electrode for an all-solid-state battery, in which a diameter (D₉₀) corresponding to 90% of the cumulative volume in the cumulative volume distribution of the base body ranges from 13 μm to 25 μm.

The present disclosure provides an electrode for an all-solid-state battery, in which the base body has a SPAN value of at most 1.9 based on Equation 1 below,

$$SPAN = \frac{{D}_{90} - {D}_{10}}{{D}_{50}} \qquad Equation 1$$

wherein D₁₀ is a diameter (D₁₀) corresponding to 10% of the cumulative volume, in a cumulative volume distribution of the base body,
D₅₀ is a diameter (D₅₀) corresponding to 50% of the cumulative volume, in the cumulative volume distribution of the base body, and
D₉₀ is a diameter (D₉₀) corresponding to 90% of the cumulative volume, in the cumulative volume distribution of the base body.

The present disclosure provides an electrode for an all-solid-state battery, in which the plurality of base bodies are stacked and spaced apart from each other along a stack direction.

The present disclosure provides an electrode for an all-solid-state battery, in which, based on a total number of separation spaces, a proportion of the total number of separation spaces includes at least 45% of the lithium deposition separation space.

The present disclosure provides an electrode for an all-solid-state battery, in which the lithium deposition separation space has a width ranging from 2 nm to 8 nm.

The present disclosure provides an electrode for an all-solid-state battery, in which a particle size of the base body in a (002) direction ranges from 5 nm to 30 nm.

The present disclosure provides an electrode for an all-solid-state battery, in which the intermediate layer includes the carbon structure in a content ranging from 85 wt % to 97.5 wt %.

The present disclosure provides an electrode for an all-solid-state battery, in which the intermediate layer includes the carbon structure having a density ranging from 0.8 g/cm³ to 2.0 g/cm³.

The present disclosure provides an anodeless all-solid-state battery including an anode current collector, an intermediate layer including a carbon structure and disposed on the anode current collector, a solid electrolyte layer disposed on the intermediate layer, a cathode active material layer including a cathode active material and disposed on the solid electrolyte layer, and a cathode current collector disposed on the cathode active material layer. The carbon structure includes a plurality of base bodies arranged with separation spaces formed between adjacent base bodies among the plurality of base bodies, and the separation spaces include a lithium deposition separation space having a width ranging from 0.3 nm to 10 nm. The diameter (D₅₀) corresponding to 50% of the cumulative volume in the cumulative volume distribution of a base body of the plurality of base bodies ranges from 5 μm to 12 μm.

The present disclosure provides an anodeless all-solid-state battery, in which the intermediate layer has a thickness ranging from 5 μm to 20 μm, before the anodeless all-solid-state battery is driven.

The present disclosure provides an anodeless all-solid-state battery in which a lithium ion is deposited in the lithium deposition separation space, when the anodeless all-solid-state battery is charged.

The present disclosure provides an anodeless all-solid-state battery, in which an additional lithium deposition layer is not formed between the intermediate layer and the solid electrolyte layer, when the anodeless all-solid-state battery is charged.

The present disclosure provides an anodeless all-solid-state battery in which a ratio of an intensity of a Li peak to an intensity of a LiC₆ peak is at least 0.5, when an XRD analysis is analyzed with respect to the intermediate layer, after the anodeless all-solid-state battery is fully charged.

The present disclosure provides an anodeless all-solid-state battery in which the solid electrolyte layer includes a sulfide-based solid electrolyte.

The present disclosure provides a method for manufacturing an electrode for an all-solid-state battery, the method including separating a base body from a carbon material by applying energy to a mixture solution in which a carbon material and a polymer binder are solved, and rearranging a result structure through self-assembling, and preparing a carbon structure by ball-mill grinding the result structure for a time ranging from 55 minutes to 150 minutes.

The present disclosure provides a method for manufacturing an electrode for an all-solid-state battery including forming a separation space by removing the polymer binder from the mixture solution as energy is applied to the mixture solution.

(19) The present disclosure provides a method for manufacturing an electrode for an all-solid-state battery in which the polymer binder includes polyester, polyethylene vinyl acetate, polyester-polyethylene vinyl acetate copolymer, polyvinyl chloride, polyethylene, polypropylene, polybutadiene, polyolefin, polyvinyl chloride, polyvinyl acetate, polyethylene terephthalate, polystyrene, polyethylene ketone, polyethylene terephthalate glycol, polyvinylidene fluoride, polyethyleneimide, polytetrafluoroethylene, ethylene tetrafluoride, vinylidene fluoride-based copolymer, hexafluoropropylene, vinylidene fluoride/hexafluoropropylene copolymer, polyvinylidene fluoride, polyacrylonitrile, polymethyl methacrylate, polyimide, polyamide polyacrylic acid, polyvinyl alcohol, styrene butadiene imide, rubber polymer, acrylonitrile-butadiene rubber, acrylonitrile-butadiene-styrene rubber, acrylate rubber, hydroxypropylmethylcellulose, sodium carboxymethylcellulose, a composite polymer, or any combination thereof.

The present disclosure provides a method for manufacturing an electrode for an all-solid-state battery in which the ball-mill grinding is performed for a time ranging from 80 minutes to 120 minutes-.

### BRIEF DESCRIPTION OF THE DRAWINGS

The above and other objects, features and advantages of the present disclosure should be more apparent from the following detailed description taken in conjunction with the accompanying drawings.

FIG. 1 schematically illustrates the structure of an anodeless all-solid-state battery depending on driving states of the anodeless all-solid-state battery, according to an embodiment of the present disclosure.

FIG. 2 illustrates an SEM image and EDS mapping of the anodeless all-solid-state battery through SEM-EDS for the cross-section of the anodeless all-solid-state battery according to Embodiment 1 of the present disclosure i) before lithium is not deposited, ii) when lithium having the capacity of 0.5 mAh/cm² is deposited on an intermediate layer, iii) when lithium having the capacity of 1.0 mAh/cm² is deposited on the intermediate layer, and iv) when lithium having the capacity of 2.0 mAh/cm² is deposited on the intermediate layer.

FIG. 3 is an SEM image of a base body before and after an anodeless all-solid-state battery according to Embodiment 1 of the present disclosure is driving.

FIG. 4 illustrates an XPS analysis result of an intermediate layer, which is measured before an anodeless all-solid-state battery according to Embodiment 1 of the present disclosure is driven.

FIG. 5 illustrates an XPS analysis result of an intermediate layer, which is measured after an anodeless all-solid-state battery according to Embodiment 1 of the present disclosure is driven.

FIG. 6 is an SEM image for an intermediate layer of an anodeless all-solid-state battery according to Embodiment 1 of the present disclosure.

FIG. 7 illustrates a Raman spectrum measured with respect to an intermediate layer in each of anodeless all-solid-state batteries according to Embodiment 1 and Comparative example 1 of the present disclosure.

FIG. 8 illustrates a XRD spectrum measured with respect to an intermediate layer in each of anodeless all-solid-state batteries according to Embodiment 1 and Comparative example 1 of the present disclosure.

FIG. 9 illustrates an XRD spectrum for an intermediate layer measured after lithium having the capacity of 2.0 mAh/cm² is deposited on an intermediate layer in each of anodeless all-solid-state batteries according to Embodiment 1 and Comparative example 1 of the present disclosure.

FIG. 10 illustrates a GTT measurement result for a first discharge process of each of half-cells according to Embodiment 1 and Comparative example 1 of the present disclosure.

FIG. 11 is a graph illustrating the cycle performance of each of anodeless all-solid-state batteries according to Embodiment 1 and Comparative example 1 of the present disclosure.

FIG. 12 illustrates an SEM image of each of the base bodies according to Embodiment 1 and Comparative example 2 of the present disclosure.

FIG. 13 illustrates a cycle performance graph of each of half-cells according to Embodiment 1 and Comparative example 2 of the present disclosure.

### DETAILED DESCRIPTION

Hereinafter, the present disclosure is described in more detail for the understanding of the present disclosure. For example, terms or words used in the present specification and the claims should not be interpreted as commonly-used dictionary meanings, but be interpreted as to be relevant to the technical scope of the present disclosure based on the fact that the inventor may properly define the concept of the terms to explain the present disclosure in best ways.

The terms used in the present disclosure are provided only for the illustrative purpose, and the present disclosure is not limited thereto. The singular forms are intended to include the plural forms unless the context clearly indicates otherwise.

In this specification, it should be further understood that the terms “comprises,” “includes,” or “has,” specify the presence of stated features, numbers, steps, components, parts, or the combination thereof, but do not preclude the presence or addition of one or more other features, numbers, steps, components, and/or the combination thereof.

Anodeless all-Solid-State Battery

The present disclosure provides an anodeless all-solid-state battery including an electrode for an all-solid-state battery.

According to an embodiment of the present disclosure, an anodeless all-solid-state battery at least includes an anode current collector 40, an intermediate layer 30 which is disposed on the anode current collector 40 and includes a carbon structure, a solid electrolyte layer 20 disposed on the intermediate layer 30, a cathode active material layer 12 disposed on the solid electrolyte layer 20, and including a cathode active material, and a cathode current collector 11 disposed on the cathode active material layer 12. The carbon structure includes a plurality of base bodies 31 and a separation space formed as the base bodies 31 are spaced apart from each other. The separation space includes a lithium deposition separation space having a width ranging from 0.3 nm to 10 nm. A diameter (D₅₀) corresponding to 50% of the cumulative volume in a cumulative volume distribution of the base body may range from 5 μm to 12 μm.

An all-solid-state battery includes a cathode active material layer 12 bonded to a cathode current collector, an anode active material layer bonded to an anode current collector, and a solid electrolyte layer interposed between the anode active material layer and the cathode active material layer. However, the anode active material layer includes a solid electrolyte for moving lithium ions in addition to the anode active material, such as graphite, and the solid electrolyte has a specific gravity higher than a specific gravity of a liquid electrolyte. Accordingly, an energy density of the all-solid-state battery is lower than an energy density of a lithium ion battery using the liquid electrolyte.

To increase the energy density of the all-solid-state battery, studies and researches have been actively performed on an anodeless all-solid-state battery in a storage type to directly precipitate lithium ions in the form of lithium metal on the anode current collector, without the anode active material layer. A conventional anodeless all-solid-state battery includes an intermediate layer interposed between the solid electrolyte layer and the anode current collector and including a carbon material, to uniformly precipitate and deposit lithium. When charging the anodeless all-solid-state battery, lithium ions (Lit) of the cathode reach the intermediate layer through the solid electrolyte layer. After making reaction with the carbon material and moving, the lithium ions (Lit) are precipitated between the anode current collector and the intermediate layer. However, when graphite, which serves as a carbon material, is included in the intermediate layer of the anodeless all-solid-state battery, active lithium is consumed due to uncontrolled lithium dendrite growth and a side reaction, and lithium ions are precipitated between the solid electrolyte layer and the intermediate layer due to the crystallinity of graphite, thereby causing an internal short circuit. Accordingly, the lifespan of the anodeless all-solid-state battery may be shortened.

According to an embodiment of the present disclosure, in the anodeless all-solid-state battery, the intermediate layer includes a separation space (or lithium deposition separation space) 32 for lithium deposition. For example, the base body forming the lithium deposition separation space 32 includes base bodies which have a diameter (D₅₀) corresponding to 50% of the cumulative volume in the cumulative volume distribution of the base body and range from 5 μm to 12 μm. Accordingly, when the anodeless all-solid-state battery is charged and the lithium ion is deposited, the lithium ion may be deposited inside the intermediate layer, instead of being deposited in the form of an additional layer between the solid electrolyte layer and the intermediate layer, thereby preventing an internal short circuit, which is caused, as a lithium deposition layer is separately formed between the solid electrolyte layer and the intermediate layer, and improving a lifespan characteristic.

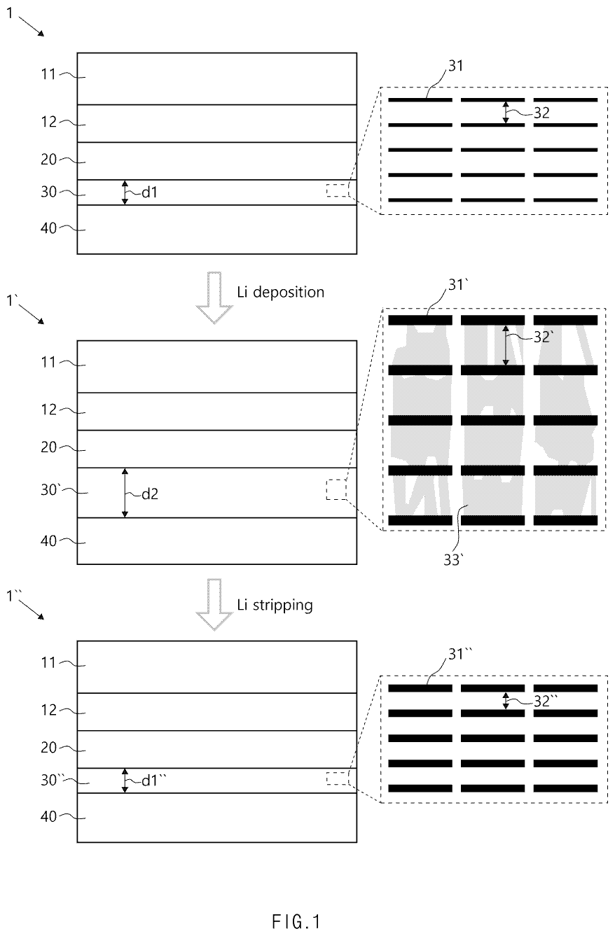

Hereinafter, each component constituting the anodeless all-solid-state battery according to an embodiment of the present disclosure is described in detail with reference to FIG. 1. FIG. 1 schematically illustrates the structure of an anodeless all-solid-state battery depending on driving states of the anodeless all-solid-state battery, according to an embodiment of the present disclosure. FIG. 1 illustrates an anodeless all-solid-state battery in an initial state (i.e., a fully discharged state before initially charged), an anodeless all-solid-state battery 1′ fully charged (or in a fully charged state), and an anodeless all-solid-state battery 1″ fully discharged (or in a fully discharged state) after the fully charged state. Hereinafter, each component of the anodeless all-solid-state battery according to an embodiment of the present disclosure is described while focusing on the anodeless all-solid-state battery 1 in the initial state unless defined otherwise.

Electrode for all-Solid-State Battery

The anodeless all-solid-state battery according to an embodiment of the present disclosure may include an electrode for an all-solid-state battery. The electrode for the all-solid-state battery at least includes a current collector, and an intermediate layer disposed on the current collector and including a carbon structure. The carbon structure includes a plurality of base bodies and a separation space, which is formed as base bodies are spaced apart from each other, and the separation space includes the lithium deposition separation space, which has a width ranging from 0.3 nm to 10 nm. The diameter (D₅₀) corresponding to 50% of the cumulative volume in a cumulative volume distribution of the base body ranges from 5 μm to 12 μm.

According to an embodiment of the present disclosure, the electrode for the all-solid-state battery is an electrode in which an anode active material layer is omitted, and lithium ions are directly precipitated in the form of lithium metal on the current collector. In addition, the electrode may substantially serve as an anode in an anodeless all-solid-state battery. Accordingly, hereinafter, the current collector included in the electrode for the all-solid-state battery is referred to as the anode current collector 40.

### Anode Current Collector

According to an embodiment of the present disclosure, the anode current collector 40, which serves as a plate-shaped base having electrical conductivity, may include a material which does not react with lithium. The anode current collector 40 include various materials without being specially limited, as long as the materials have conductivity without inducing a chemical change in a relevant battery (the anodeless all-solid-state battery according to the present disclosure). For example, the anode current collector 40 may be aluminum (Al), nickel (Ni), titanium (Ti), tungsten (W), iron (Fe), chromium (Cr), and stainless steel, or the alloy thereof.

### Intermediate Layer

According to an embodiment of the present disclosure, the intermediate layer 30, which is a component directly disposed on the anode current collector 40, may induce deposition of lithium metal in a horizontal direction along the surface of the anode current collector 40, when lithium ions are precipitated in the form of lithium metal on the surface of the anode current collector 40.

According to an embodiment of the present disclosure, the intermediate layer 30 may include a carbon structure including a plurality of base bodies 31 and a lithium deposition separation space 32, which is formed as the plurality of base bodies 31 are spaced apart from each other, and has a width ranging from 0.3 nm to 10 nm.

According to an embodiment of the present disclosure, a diameter (D₅₀) corresponding to 50% of the cumulative volume in a cumulative volume distribution of the base body, which is measured through a Laser Diffraction Grain Size Analyzer, may range from 5 μm to 12 μm. The diameter (D₅₀) corresponding to 50% of the cumulative volume may be at least 5.5 μm, at least 6 μm, at least 6.5 μm, at least 7 μm, at least 7.5 μm, or at least 8 μm, and at most 11.5 μm, at most 11 μm, at most 10.5 μm, at most 10 μm, at most 9.5 μm, or at most 9 μm. When the diameter (D₅₀) corresponding to 50% of the cumulative volume satisfies the above range, a lithium deposition mechanism may be easily performed, so lithium may be smoothly deposited inside the carbon structure. When D₅₀ of the base body 31 exceeds the above range, the lithium deposition separation space 32, which is formed from the base bodies, is reduced in the carbon structure. Accordingly, the lithium deposition mechanism to be described below may not be easily performed, so the lithium deposition may fail in the carbon structure. In addition, when D₅₀ of the base body 31 is less than the above range, the internal crystal structure of the base body 31 may be changed, so the lithium deposition may fail in the carbon structure.

According to an embodiment of the present disclosure, a diameter (D₁₀) corresponding to 10% of the cumulative volume in a cumulative volume distribution of the base body, which is measured through a Laser Diffraction Grain Size Analyzer, may range from 1.5 μm to 4.5 μm. The D₁₀ may be at least 1.6 μm, at least 1.7 μm, at least 1.8 μm, at least 1.9 μm, or at least 2 μm, and at most 4.4 μm, at most 4.3 μm, at most 4.2 μm, at most 4.1 μm, or at most 4 μm. When D₁₀ of the base body satisfies the above range, the lithium deposition mechanism to be described below may be more easily performed.

According to an embodiment of the present disclosure, a diameter (D₉₀) corresponding to 90% of the cumulative volume in a cumulative volume distribution of the base body, which is measured through a Laser Diffraction Grain Size Analyzer, may range from 13 μm to 25 μm. The D₉₀ of the base body may be at least 13.5 μm, at least 14 μm, at least 14.5 μm, at least 15 μm, at least 15.5 μm, or at least 16 μm, and at most 24.5 μm, at most 24 μm, at most 23.5 μm, at most 23 μm, at most 22.5 μm, or at most 22 μm. When D₉₀ of the base body satisfies the above range, the lithium deposition mechanism to be described below may be more easily performed.

According to an embodiment of the present disclosure, the base body 31 may have a SPAN value of at most 1.9 based on Equation 1 below:

$$SPAN = \frac{{D}_{90} - {D}_{10}}{{D}_{50}} \qquad Equation 1$$

wherein D₁₀ is a diameter (D₁₀) corresponding to 10% of the cumulative volume, in a cumulative volume distribution of the base body, D₅₀ is a diameter (D₅₀) corresponding to 50% of the cumulative volume, in a cumulative volume distribution of the base body, and D₉₀ is a diameter (D₉₀) corresponding to 90% of the cumulative volume, in a cumulative volume distribution of the base body.

According to an embodiment of the present disclosure, the SPAN value expressed based on Equation 1 may be at least 0.5, at least 0.6, at least 0.8, at least 1, at least 1.2 or at least 1.4, and at most 1.85, at most 1.8, at most 1.75, at most 1.7, or at most 1.65. When the SPAN value satisfies the above range, the lithium deposition mechanism to be described below may be more easily performed.

According to an embodiment of the present disclosure, the base body 31 may be a plate-shaped particle. According to the present disclosure, a plate is understood as a concept including not only planar shapes with uniform thickness profiles, but also shapes that are curved, where a plane with a uniform thickness profile is folded and perceived as curved.

According to an embodiment of the present disclosure, the base body 31 may have a width in a thickness direction, i.e., a particle size in a (002) direction, which ranges from 5 nm to 30 nm. The width in the thickness direction, i.e., the particle size in the (002) direction may be at least 6 nm, at least 8 nm, at least nm, at least 12 nm, or at least 15 nm, and may be at most 28 nm, at most 26 nm, at most 24 nm, at most 22 nm, or at most 20 nm. When the width in the thickness direction, i.e., the particle size in the (002) direction satisfies the above range, the lithium deposition mechanism may be easily performed, so lithium may be smoothly deposited inside the carbon structure.

According to an embodiment of the present disclosure, the base body 31 may be a graphene platelet in which graphene is disorderly stacked or stratified carbon in which graphene is combined.

According to an embodiment of the present disclosure, the plurality of base bodies 31 are stacked, and spaced apart from each other in a stack direction, thereby forming the lithium deposition separation space. Specifically, the plurality of base bodies 31 are entirely or partially spaced apart from each other to form the lithium deposition separation space, and the lithium deposition separation space may include the lithium deposition separation space 32 having the width ranging from 0.3 nm to 10 nm.

According to an embodiment of the present disclosure, based on the total number of the separation spaces, the proportion of the number of the lithium deposition separation space 32 may be at least 45%, and may be at least 50%, at least 55%, at least 60%, at least 65%, at least 70%, at least 75%, at least 80%, at least 85%, or at least 90%. When the proportion of the number of the lithium deposition separation space 32 satisfies the above range, the lithium ion may be more easily deposited in the intermediate layer 30.

Referring to FIG. 1, according to an embodiment of the present disclosure, the lithium deposition separation space 32 has a width significantly narrower than a width of an air pore of a porous graphite in the related art. The lithium deposition separation space 32 has a width ranging from 0.3 nm to 10 nm in the stack direction. Specifically, the lithium deposition separation space 32 may have a width of at least 0.4 nm, at least 0.6 nm, at least 0.8 nm, at least 1.0 nm, at least 1.2 nm, at least 1.4 nm, at least 1.6 nm, at least 1.7 nm, at least 1.8 nm, or at least 2.0 nm, and have a width of at most 9.8 nm, at most 9.6 nm, at most 9.4 nm, at most 9.2 nm, at most 9.0 nm, at most 8.8 nm, at most 8.6 nm, at most 8.4 nm, at most 8.2 nm, or at most 8.0 nm. When the width satisfies the above range, and when the anodeless all-solid-state battery is charged, the lithium ion may be perfectly deposited in the intermediate layer 30 without being deposited between the solid electrolyte layer 20 and the intermediate layer 30 or forming a lithium dendrite. When the width of the lithium deposition separation space 32 is less than the above range, the width is narrower than a width of a metal ion. Accordingly, the lithium ion fails to be deposited in the lithium deposition separation space 32. When the width of the lithium deposition separation space 32 exceeds the above range, the lithium ion may pass through the lithium deposition separation space 32 without being deposited, and may be deposited between the solid electrolyte layer 20 and the intermediate layer 30, thereby causing the internal short circuit.

According to an embodiment of the present disclosure, when an X-ray Diffraction (XRD) analysis is performed with respect to the carbon structure, a full width at half maximum width (FWHM; 2θ) of a (002) peak may range from 0.3° to 0.8°. The FWHM may be at least 0.32°, at least 0.34°, at least 0.36°, at least 0.38°, or at least 0.4°, and may be at most 0.78°, at most 0.76°, at most 0.74°, at most 0.72° or at most 0.7°. When the FWHM satisfies the above range, as the width of the lithium deposition separation space 32 and the number of the lithium deposition spaces 32 satisfy the above range in the carbon structure, the lithium may be easily deposited inside the carbon structure.

According to an embodiment of the present disclosure, when a Raman spectrum is measured with respect to the carbon structure, a spectrum in a Raman shift range from 2,600/cm to 2,800/cm is observed as one peak, and the spectrum is fitted with a single Voigt profile to define a fitting curve. Thereafter, each coefficient of determination (R²) for the fitting curve may be at least 0.985.

According to an embodiment of the present disclosure, the coefficient of determination (R²) of the fitting curve for the spectrum may be at least 0.986, at least 0.987, at least 0.988, at least 0.989, at least 0.99, or at least 0.992. A spectrum in a Raman shift range from 2, 600/cm to 2,800/cm is observed as one peak. When the spectrum satisfies the above-described range, the lithium deposition separation space 32 having the width in the above range may be formed in the carbon structure.

According to an embodiment of the present disclosure, the intermediate layer 30 may further include a conductive material, a solid electrolyte, and/or a binder.

According to an embodiment of the present disclosure, the conductive material may further improve the conductivity of the intermediate layer 30. The conductive material may include various materials without being specially limited, as long as the materials have conductivity without inducing a chemical change in the relevant battery. For example, the conductive material may include graphite; a carbon-based material, such as carbon black, acetylene black, ketjen black, channel black, furnace black, lamp black, thermal black, and SC65; a conductive fiber such as a carbon fiber or a metal fiber; metal powders such as a carbon fluoride, aluminum or nickel powders; conductive whisker such as zinc oxide or potassium titanate; a conductive metal oxide such as a titanium oxide; a conductive material, such as a polyphenylene derivative.

According to an embodiment of the present disclosure, the binder may facilitate the binding between the conductive material and the carbon structure. The binder may be polyvinylidene fluoride, polyvinyl alcohol, carboxymethylcellulose, starch, hydroxypropylcellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene rubber, nifril-butadiene rubber, fluorine rubber, and various copolymers thereof.

The intermediate layer 30 according to an embodiment of the present disclosure may include the carbon structure in a content ranging from 85 wt % to 97.5 wt %, and may include the carbon structure, in a content at least 86 wt %, at least 87 wt %, at least 88 wt %, at least 89 wt %, or at least 90 wt %, and at most 97 wt, at most 96.5 wt %, at most 96 wt %, at most 95.5 wt %, at most 95 wt %, or at most 94.5 wt %. When the content of the carbon structure satisfies the above range, the lithium ion may be more easily deposited in the intermediate layer 30.

The intermediate layer 30 according to an embodiment of the present disclosure may include the carbon structure at a density ranging from 0.8 g/cm³ to 2.0 g/cm³. The carbon structure may be included at the density of at least 0.85 g/cm³, at least 0.9 g/cm³, at least 0.95 g/cm³, at least 1.0 g/cm³, at least 1.1 g/cm³, or at least 1.2 g/cm³, and may be included at the density of at most 1.9 g/cm³, at most 1.8 g/cm³, at most 1.7 g/cm³, at most 1.6 g/cm³, at most 1.5 g/cm³, or at most 1.4 g/cm³. When the density of the carbon structure satisfies the above range, the lithium ion may be more easily deposited in the intermediate layer 30.

According to an embodiment of the present disclosure, the anodeless all-solid-state battery includes the intermediate layer 30 including the carbon structure including a plurality of base bodies and a lithium deposition separation space, which is formed as the plurality of bodies are spaced apart from each other and has the width ranging from 0.3 nm to 10 nm. Accordingly, when the anodeless all-solid-state battery is charged with power, the lithium ion may be deposited in the lithium deposition separation space 32 inside the intermediate layer 30, and a lithium deposition layer may not be additionally formed between the intermediate layer 30 and the solid electrolyte layer 20. Accordingly, the solid electrolyte layer 20 may be prevented from directly making contact with the deposited lithium, thereby preventing the internal short circuit from being caused.

According to an embodiment of the present disclosure, the thickness of the intermediate layer 30 included in the anodeless all-solid-state battery may be varied depending on the driving states of the anodeless all-solid-state battery. When the anodeless all-solid-state battery is charged, the thickness of the intermediate layer 30 may be increased. When the anodeless all-solid-state battery is discharged, the thickness of the intermediate layer 30 may be reduced. FIG. 1 illustrates the anodeless all-solid-state battery 1 in the initial state (i.e., a fully discharged state before initially charged), the anodeless all-solid-state battery 1′ in the fully charged state, and the anodeless all-solid-state battery 1″ in the fully discharged state after the fully charged state. Hereinafter, a lithium deposition mechanism of the anodeless all-solid-state battery according to an embodiment of the present disclosure is described in detail.

According to an embodiment of the present disclosure, a base body 31′ of the anodeless all-solid-state battery 1′, which is in the fully charged state, may form LiC₆ through reaction with lithium ions. Accordingly, the base body 31′ may have a volume larger than a volume of the base body 31 before charged.

According to an embodiment of the present disclosure, the base body 31′, which is in the fully charged state, may have a width in a thickness direction, i.e., a particle size in a (002) direction, which ranges from 7 nm to 41 nm. The width in the thickness direction, i.e., the particle size in the (002) direction may be at least 8 nm, at least 9 nm, at least 10 nm, at least 12 nm, or at least 15 nm, and may be at most 40 nm, at most 38 nm, at most 36 nm, at most 34 nm, at most 32 nm, or at most 30 nm.

According to an embodiment of the present disclosure, the LiC₆ formed in the base body 31′ in the fully charged state provides a path for moving lithium ions to a lithium deposition separation space 32′, and the lithium ion may be deposited in the form of lithium metal in the lithium deposition separation space 32′ to form a lithium deposition body 33′.

According to an embodiment of the present disclosure, a lithium deposition body 33′ may be formed in the lithium deposition separation space 32′ of the anodeless all-solid-state battery 1′ in the fully charged state. When an XRD analysis is performed with respect to the intermediate layer 30′ including the lithium deposition body 33′, the ratio of the intensity of the Li (110) peak to the intensity of the LiC₆ (001) peak may be at least 0.5. The ratio of the intensity of the Li (110) peak to the intensity of the LiC₆ (001) peak may be at least 0.6, at least 0.7, at least 0.8, at least 0.9, or at least 1.

According to an embodiment of the present disclosure, the width of the lithium deposition separation space 32′ may be increased by the lithium deposition body 33′ formed in the lithium deposition separation space 32′, as compared to the lithium deposition separation space 32 in the initial state. This is because the lithium ion is deposited in the lithium deposition separation space 32 to form the lithium deposition body when the anodeless all-solid-state battery 1 in the initial state is charged, and the base body 31 forming the lithium deposition separation space 32 is pushed up to increase the width of the lithium deposition separation space 32, as the lithium deposition body is grown.

According to an embodiment of the present disclosure, the lithium deposition separation space 32′ of the anodeless all-solid-state battery 1′ in the fully charged state may have a width ranging from 3 nm to 20 nm in the stack direction. The lithium deposition separation space 32′ may have a width of at least 3.5 nm, at least 4 nm, at least 4.5 nm, at least 5 nm, at least 5.5 nm, at least 6 nm, at least 6.5 nm, at least 7 nm, at least 7.5 nm, or at least 8 nm, and may have at most 19 nm, at most 18 nm, at most 17 nm, at most 16 nm, at most 15 nm, at most 14 nm, or at most 13 nm.

Referring to FIG. 1, as described above, when the anodeless all-solid-state battery 1 in the initial state is charged to be the anodeless all-solid-state battery 1′ in the fully charged state, the volume of the base body 31′ in the fully charged state is increased, as compared to the base body 31 in the initial state, and the width of the lithium deposition separation space 32′ in the fully charged state is increased as compared to the lithium deposition separation space 32 in the initial state. Accordingly, the thickness d2 of the intermediate layer 30′ of the anodeless all-solid-state battery 1′ in the fully charged state may be thicker than the thickness d1 of the intermediate layer 31 of the anodeless all-solid-state battery 1 in the initial state.

According to an embodiment of the present disclosure, when the anodeless all-solid-state battery is in the initial state (i.e., fully discharged before initially charged), the thickness d1 of the intermediate layer 30 may range from 5 μm to 20 μm. The thickness d1 of the intermediate layer 30 may be at least 5.5 μm, at least 6 μm, at least 6.5 μm, at least 7 μm, at least 7.5 μm, or at least 8 μm, and may have at most 19 μm, at most 18 μm, at most 17 μm, at most 16 μm, or at most 15 μm. When the thickness d1 of the intermediate layer 30 satisfies the above range, the lithium deposition may be more easily performed, and the energy density of the anodeless all-solid-state battery may be more improved.

According to an embodiment of the present disclosure, the thickness d2 of the intermediate layer 30′ of the anodeless all-solid-state battery 1′ in the fully charged state may range from 10 μm to 50 μm. The thickness d2 of the intermediate layer 30′ may be at least 12 μm, at least 14 μm, at least 16 μm, at least 18 μm, or at least 20 μm, and may have at most 45 μm, at most 40 μm, at most 35 μm, or at most 30 μm.

According to an embodiment of the present disclosure, the ratio (d1/d2) of the thickness d2 to the thickness d1 may be at least 2, and may be at least 2.2, at least 2.4, at least 2.6, at least 2.8, or at least 3.

According to an embodiment of the present disclosure, when the anodeless all-solid-state battery 1′ in the fully charged state is discharged to be the anodeless all-solid-state battery 1″ in the fully discharged state, the lithium ion is drained out of the intermediate layer 30′. Accordingly, the intermediate layer 30″ of the anodeless all-solid-state battery 1″ in the fully discharged state may be in a state similar to the state of the anodeless all-solid-state battery 1 in the initial state. The thickness d1″ of the intermediate layer 30″ in the fully discharged state after a charged state may be substantially the same as the thickness d1 of the intermediate layer 30 in the initial state.

According to an embodiment of the present disclosure, the base body 31″ in the fully discharged state after charged (or in a charged state) may have a particle size larger than a particle size of the base body 31 in the initial state, and may have the particle size smaller than a particle size of the base body 31′ in the fully charged state.

According to an embodiment of the present disclosure, the base body 31″ in the fully discharged state may have a width in a thickness direction, i.e., a particle size in a (002) direction, which ranges from 6 nm to 31 nm. The width in the thickness direction, i.e., the particle size in the (002) direction, may be at least 7 nm, at least 8 nm, at least 10 nm, at least 12 nm, or at least 15 nm, and may be at most 30 nm, at most 28 nm, at most 26 nm, at most 24 nm, or at most 22 nm.

Therefore, according to an embodiment of the present disclosure, the lithium deposition separation space 32″ in the fully discharged state after the charged state may have a width narrower than the width of the lithium deposition separation space 32 in the initial state. The lithium deposition separation space 32″ in the fully discharged state after the charged state may have a width ranging from 0.3 nm to 8 nm in the stack direction. The lithium deposition separation space 32″ may have a width of at least 0.32 nm, at least 0.34 nm, at least 0.38 nm, at least 0.4 nm, at least 0.42 nm, at least 0.44 nm, at least 0.46 nm, at least 0.48 nm, or at least 0.5 nm, and may have a width of at most 7.8 nm, at most 7.6 nm, at most 7.4 nm, at most 7.2 nm, at most 7.0 nm, at most 6.8 nm, at most 6.6 nm, at most 6.4 nm, at most 6.2 nm, or at most 6.0 nm. When the width of the lithium deposition separation space 32″ satisfies the above range, as the base body 31″ in the fully discharged state after the charged state has a particle size larger than a particle size of the base body 31 in the initial state, even if the lithium deposition separation space 32″ in the fully discharged state after the charged state may have a width narrower than a width of the lithium deposition separation space 32 in the initial state, the lithium ion may be deposited in the intermediate layer 30 without being deposited between the solid electrolyte layer 20 and the intermediate layer 30 or forming a lithium dendrite.

According to an embodiment of the present disclosure, as the anodeless all-solid-state battery employs the carbon structure having the above-described structure, for the intermediate layer 30, when the anodeless all-solid-state battery is charged, the lithium ion may be deposited in the intermediate layer 30 without being deposited between the solid electrolyte layer 20 and the intermediate layer 30 or forming a lithium dendrite.

According to one embodiment of the present disclosure, a method for manufacturing for an electrode for the all-solid-state battery at least includes the steps for separating a base body from a carbon material by applying energy to a mixture solution in which the carbon material and a polymer binder are solved, and for rearranging the result structure through self-assembling (S1), and preparing a carbon structure by ball-mill grinding the result structure for a time ranging from 55 minutes to 150 minutes (S2).

‘S1’ is to separate the base body, i.e., graphene from the carbon material by applying energy to the mixture solution in which the carbon material, i.e., graphite, is solved, and for rearranging the result structure through self-assembling.

According to an embodiment of the present disclosure, the mixture solution may further include the polymer binder. However, the polymer binder is removed by the energy, such that the plurality of separation spaces are formed in place of the polymer binder. A separation space, which has a width ranging from 0.3 nm to 10 nm in the thickness direction, of the separation spaces may be defined as a lithium deposition separation space.

The graphite is the carbon material including air pores. When energy is applied to the graphite including the polymer binder, the graphite may be compressed such that the size of the pores and the number of the air pores are reduced, and remaining air pores may be filled with the polymer binder. Thereafter, when the polymer binder is removed by the energy, the remaining air pores become separation spaces to form the carbon structure. A separation space, which is a width ranging from 0.3 nm to 10 nm in the thickness direction, of the separation spaces may be defined as a lithium deposition separation space.

According to an embodiment of the present disclosure, the energy may be applied through various manners such as heat treatment, light irradiation, and ultrasonic treatment, and through heat treatment.

According to an embodiment of the present disclosure, after the polymer binder is removed, some of the polymer binders may remain on the surface of the base body.

According to an embodiment of the present disclosure, the polymer binder may include polyester, polyethylene vinyl acetate, Polyester-polyethylene vinyl acetate copolymer, polyvinyl chloride, polyethylene, polypropylene, polybutadiene, polyolefin, polyvinyl chloride, polyvinyl acetate, polyethylene terephthalate, polyethylene terephthalate polystyrene, polyethylene ketone, glycol, polyethyleneimide, polyvinylidene fluoride, polytetrafluoroethylene, ethylene tetrafluoride, vinylidene fluoride-based copolymer, hexafluoropropylene, vinylidene fluoride/hexafluoropropylene copolymer, polyvinylidene fluoride, polyacrylonitrile, polymethyl methacrylate, polyimide, polyamide imide, polyacrylic acid, polyvinyl alcohol, styrene butadiene rubber polymer, acrylonitrile-butadiene rubber, acrylonitrile-butadiene-styrene rubber, acrylate rubber, hydroxypropylmethylcellulose, sodium carboxymethylcellulose, a composite polymer including at least one material of the above materials, or any combination thereof.

According to an embodiment of the present disclosure, when the carbon structure is prepared, as a lithiophilic polymer binder is used, the lithiophilic polymer binder may remain on the base body. For example, since lithium ions may be attracted during the process of lithium deposition, lithium ions may be stably deposited uniformly with a high capacity.

According to an embodiment of the present disclosure, in step (S2), the carbon structure may be prepared with a base body particle distribution in a range by performing ball-mill grinding with respect to the result structure in ‘S1’ for a time ranging from 55 minutes to 150 minutes. The ball-mill grinding may be performed for at least 60 minutes, at least 65 minutes, at least 70 minutes, at least 75 minutes, at least 80 minutes, at least 85 minutes, or at least 90 minutes, and may be performed for at most 145 minutes, at most 140 minutes, at most 135 minutes, 130 minutes, at most 125 minutes, or at most 120 minutes. When the ball-mill grinding satisfies the above condition, the diameter (D₅₀) corresponding to 50% of the cumulative volume is adjusted to be in the range from 5 μm to 12 μm. Accordingly, the lithium deposition mechanism may be easily performed, such that lithium may be smoothly deposited inside the carbon structure.

### Solid Electrolyte Layer

According to an embodiment of the present disclosure, the all-solid-state battery may include the solid electrolyte layer 20. The solid electrolyte layer 20 may be interposed between the cathode active material layer 12 and the intermediate layer 30 to transfer lithium ions between the cathode active material layer 12 and the anode current collector 40.

According to an embodiment of the present disclosure, the solid electrolyte layer 20 may be disposed on the intermediate layer 30 and may include a solid electrolyte having lithium ion conductivity. The solid electrolyte includes an oxide-based solid electrolyte, a sulfide-based solid electrolyte, a polymer electrolyte, or a combination thereof, and may include a sulfide-based solid electrolyte.

According to an embodiment of the present disclosure, the sulfide-based solid electrolyte may include Li₆PS₅X (X=at least one selected from the group consisting of Cl, Br and I), Li₁₀GeP₂S₁₂, Li₃PS₄, Li₇P₃S₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (in which ‘m’ and ‘n’ is positive numbers; Z is one of Ge, Zn, and Ga), Li₂S—GeS₂, Li₂S—SiS₂—Li₃PO₄, Li₂S—SiS₂-LiₓMO_{y} (in which ‘x’ and ‘y’ are positive numbers; M is one among P, Si, Ge, B, Al, Ga, and In), or a combination thereof.

### Cathode

According to an embodiment of the present disclosure, the cathode may include the cathode active material layer 12 and the cathode current collector 11.

### Cathode Active Material Layer

According to an embodiment of the present disclosure, the cathode active material layer 12 may include a cathode active material, a conductive material, and a binder.

According to an embodiment of the present disclosure, the cathode active material, which allows lithium ions (Lit) to be reversibly plated or released, may include a composite oxide (or a lithium composite metal oxide) of lithium and metal. For example, the lithium composite metal oxide may be a lithium-manganese-based oxide (e.g., LiMnO₂ or LiMn₂O₄), a lithium-cobalt-based oxide (e.g., LiCoO₂), a lithium-nickel-based oxide (e.g., LiNiO₂), a lithium-nickel-manganese-based oxide (e.g., LiNi_{1-Y}Mn_{Y}O₂ (0<Y<1), or LiMn_{2-z}Ni_{z}O₄ (0<Z<2)), a lithium-nickel-cobalt-based oxide (e.g., LiNi_{1-Y1}Co_{Y1}O₂ (0<Y1<1)), a lithium-manganese-cobalt-based oxide (e.g., LiCo_{1-Y2}Mn_{Y2}O₂ (0<Y2<1), or LiMn_{2-z1}Co_{z1}O₄ (0<Z1<2)), a lithium-nickel-manganese-cobalt-based oxide (e.g., Li(NiₚCo_{q}Mnᵣ₁)O₂ (0<p<1, 0<q<1, 0<r1<1, and p+q+r1=1) or Li(Niₚ₁Co_{q1}Mnᵣ₂)O₄ (0<p1<2, 0<q1<2, 0<r2<2, and p1+q1+r2=2)), or a lithium-nickel-cobalt-transition metal Li (Niₚ₂Co_{q2}Mnᵣ₃Mₛ₂)O₂ (′M′ is selected from the group consisting of Al, Fe, V, Cr, Ti, Ta, Mg, and Mo; p2, q2, r3 and s2 are atomic fractions of independent elements; 0<p2<1, 0<q2<1, 0<r3<1, 0<s2<1, p2+q2+r3+s2=1)), or may include any one of the above materials or a compound including at least two of the above materials.

Among them, the lithium composite metal oxide may be LiCoO₂, LiMnO₂, LiNiO₂, a lithium nickel manganese cobalt oxide (e.g., Li(Ni_{1/3}Mn_{1/3}Co_{1/3})O₂, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂ and Li(Ni_{0.8}Mn_{0.1}Co_{0.1})O₂), or a lithium nickel cobalt aluminum oxide (e.g., Li(Ni_{0.8}Co_{0.15}Al_{0.05})O₂) to enhance a capacity characteristic and stability of a battery. When considering an effect remarkably improved by controlling the type and content ratio of components forming the lithium composite metal oxide, the lithium nickel manganese cobalt oxide may be Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, and Li(Ni_{0.8}Mn_{0.1}Co_{0.1})O₂, or may employ any one of the above materials, or a mixture of at least two of the above materials.

According to an embodiment of the present disclosure, the cathode active material may include boron (B) or LiNbO, and may further include a coating layer surrounding the lithium composite metal oxide. As the coating layer is further included, the structural stability of the cathode active material may be improved.

In addition, according to an embodiment of the present disclosure, the cathode active material layer 12 may further include a solid electrolyte. The solid electrolyte may coat the cathode active material. Accordingly, the interfacial compatibility between the cathode active material layer 12 and the solid electrolyte layer may be improved. The detailed description of the solid electrolyte is described above in the description about the solid electrolyte layer 20, so the detailed description of the solid electrolyte may be omitted.

According to an embodiment of the present disclosure, the conductive material may serve to further improve the conductivity of the cathode active material. The conductive material may include various materials without being specially limited, as long as the materials have conductivity without inducing a chemical change in the relevant battery. For example, the conductive material may include graphite; a carbon-based material, such as carbon black, acetylene black, ketjen black, channel black, furnace black, lamp black, thermal black, and SC65; a conductive fiber such as a carbon fiber or a metal fiber; metal powders such as carbon fluoride, aluminum or nickel powders; conductive whisker such as a zinc oxide or a potassium titanate; a conductive metal oxide such as a titanium oxide; and a conductive material, such as a polyphenylene derivative.

According to an embodiment of the present disclosure, the binder may facilitate bonding among the conductive material, the cathode active material, and the cathode current collector. The binder may be polyvinylidene fluoride, polyvinyl alcohol, carboxymethylcellulose, starch, hydroxypropylcellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene rubber, nifril-butadiene rubber, fluorine rubber, and various copolymers thereof.

### Cathode Current Collector

According to an embodiment of the present disclosure, the cathode current collector 11 is not particularly limited as long as it has conductivity without causing a chemical change in the relevant battery, and may be aluminum (Al), nickel (Ni), titanium (Ti), tungsten (W), iron (Fe), chromium (Cr), and stainless steel, or an alloy thereof.

Hereinafter, an embodiment of the present disclosure is described in detail such that those having ordinary skill in the art may easily reproduce the embodiment of the present disclosure. However, the present disclosure may be implemented in various forms, and is not limited to embodiments described herein.

### Embodiment 1

After 1000 mg of graphene was put into a reactor containing 20 ml of acetone, and dispersed, 20 g of an adhesive material (manufactured by Loctite; product name: Loctite 401) was additionally introduced and stirred. Thereafter, the reactor was placed in a vacuum oven and dried at 60° C. for 3 hours, and ground with a ball mill for 105 minutes. The grounded result structure was sequentially left at 120° C. for 10 minutes, at 400° C. for 10 minutes, and at 800° C. for 5 minutes, and heat-treated through CVD. After the heat-treated result structure was sieved through a 400-mesh (37 μm) sieve, carbon structure powders were obtained.

92.5 mg of carbon structure powders prepared above, 2.5 mg of the conductive material (Super P; MTI), and 5 mg of the binder (PVDF; sigma-aldrich) were dispersed in 300 μL of an N-Methyl-2-pyrrolidone (NMP) solvent to prepare slurry. Thereafter, an anode current collector including a nickel foil having a thickness of 10 μm was prepared, and the surface of the anode current collector was uniformly coated with the prepared slurry by using a doctor blade. The coated anode current collector was put into a vacuum oven and dried at 60° C. for at least 12 hours to prepare the electrode for the all-solid-state battery having the carbon structure layer.

### Comparative Example 1

92.5 mg of graphite powders, 2.5 mg of conductive material (SuperP), and 5 mg of binder (PVDF) were dispersed in 300 μL of an N-Methyl-2-pyrrolidone (NMP) solvent to prepare slurry. Thereafter, an anode current collector including a nickel foil having a thickness of 10 μm was prepared, and the surface of the anode current collector was uniformly coated with the prepared slurry by using a doctor blade. The coated anode current collector was put into a vacuum oven and dried at 60° C. for at least 12 hours to prepare the electrode for the all-solid-state battery having the graphite layer.

### Comparative Example 2

After 1000 mg of graphene was put into a reactor containing 20 ml of acetone, and dispersed, 20 g of an adhesive material (manufactured by Loctite; product name: Loctite 401) was additionally introduced and stirred. Thereafter, the reactor was placed in a vacuum oven and dried at 60° C. for 3 hours, and ground with a ball mill for 5 minutes. The grounded result structure was sequentially left at 120° C. for 10 minutes, at 400° C. for 10 minutes, and at 800° C. for 5 minutes, and heat-treated through CVD. After the heat-treated result structure was sieved through a 400-mesh (37 μm) sieve, carbon structure powders were obtained.

92.5 mg of carbon structure powders prepared above, 2.5 mg of the conductive material (Super P; MTI), and 5 mg of the binder (PVDF; sigma-aldrich) were dispersed in 300 μL of an N-Methyl-2-pyrrolidone (NMP) solvent to prepare slurry. Thereafter, an anode current collector including a nickel foil having a thickness of 10 μm was prepared, and the surface of the anode current collector was uniformly coated with the prepared slurry by using a doctor blade. The coated anode current collector was put into a vacuum oven and dried at 60° C. for at least 12 hours to prepare the electrode for the all-solid-state battery having the carbon structure layer.

### Experimental Example 1

Manufacturing for Anodeless all-Solid-State Battery

For the electrode for an all-solid-state battery manufactured in Embodiment 1, 150 to 200 mg of a sulfide-based solid electrolyte (Li₆PS₅Cl_{0.5}Br_{0.5}) powder was filled in an annular mold having a diameter of 13 mm, and pressed under a pressure of 400 MPa to place the solid electrolyte layer. Then, the result structure was pressed under the pressure of 100 MPa, thereby forming an intermediate layer having a thickness of 10 μm between the solid electrolyte layer and the anode current collector.

Thereafter, 20 mg of mixed powders, which are obtained by mixing a cathode active material (LiNi_{0.8}Co_{0.1}Mn_{0.1}O₂), a solid electrolyte (Li₆PS₅Cl_{0.5}Br_{0.5}), and a binder (VGCF) at the ratio of 70:30:3, were placed on the opposite surface of the solid electrolyte layer, and the result structure was compressed at 200 MPa, thereby forming a cathode active material layer. Then, the cathode current collector including Al and having the thickness of 10 μm was provided to meet the top surface of the cathode active material layer, and the result structure was compressed at 380 MPa, thereby manufacturing the anodeless all-solid-state battery.

### Observation of Change in Intermediate Layer Over Charging

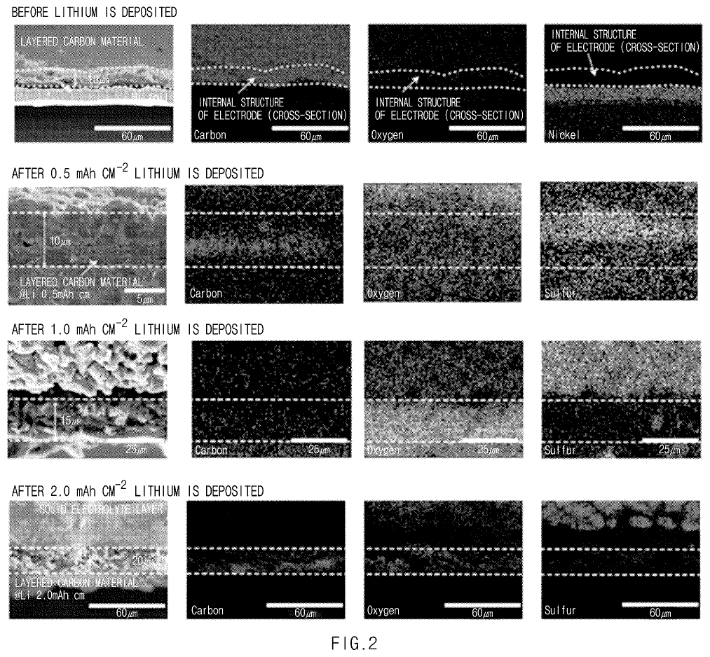

FIG. 2 illustrates a scanning electron microscope (SEM) image and Energy Dispersive X-ray Spectroscopy (EDS) mapping of the anodeless all-solid-state battery through SEM-EDS for the cross-section of the anodeless all-solid-state battery according to Embodiment 1 i) before lithium is deposited, ii) when lithium having the capacity of 0.5 mAh/cm² is deposited on the intermediate layer, iii) when lithium having the capacity of 1.0 mAh/cm² is deposited on the intermediate layer, and iv) when lithium having the capacity of 2.0 mAh/cm² is deposited on the intermediate layer. Apreo 2S produced by Thermofisher was used as SEM equipment, and ChemiSEM equipment produced by Thermofisher was used as SEM-EDS equipment.

Referring to FIG. 2, it may be recognized that the thickness of the intermediate layer including the layered carbon material gradually increases in the process of charging the relevant battery. In addition, oxygen was observed in the cross section of the intermediate layer as illustrated in FIG. 2. This means that lithium was exposed to the air to be oxidized during the measurement. Accordingly, it may be recognized that lithium was deposited inside the intermediate layer, without being precipitated in the form of an additional layer between the intermediate layer and the solid electrolyte layer.

### Observation of Structure of Base Body

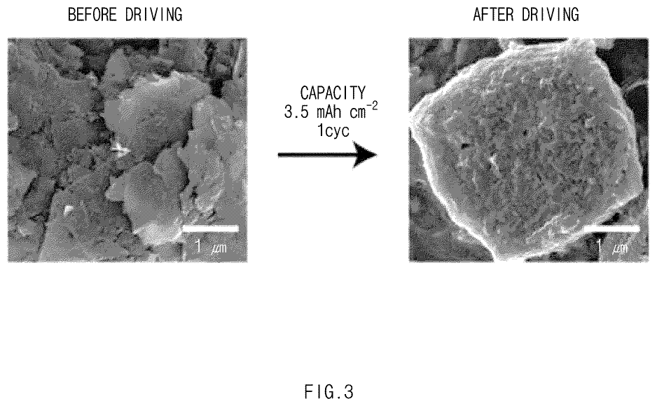

FIG. 3 illustrates an SEM image of a base body obtained by capturing, using a scanning electron microscope (SEM; Therofisher's Apreo 2S), an opposite surface to a contact surface between the intermediate layer and the solid electrolyte layer after separating the intermediate layer without separately applying a current to the anodeless all-solid-state battery according to Embodiment 1, and an SEM image of a base body, which is obtained by capturing, using the scanning electron microscope (SEM; Therofisher's Apreo 2S), the opposite surface to a contact surface between the intermediate layer and the solid electrolyte layer after depositing lithium having the capacity of 3.5 mAh/cm² on the intermediate layer and separating the intermediate layer, in the anodeless all-solid-state battery according to Embodiment 1.

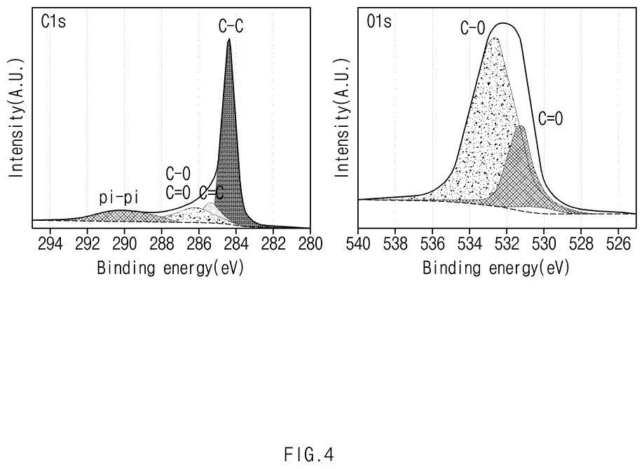

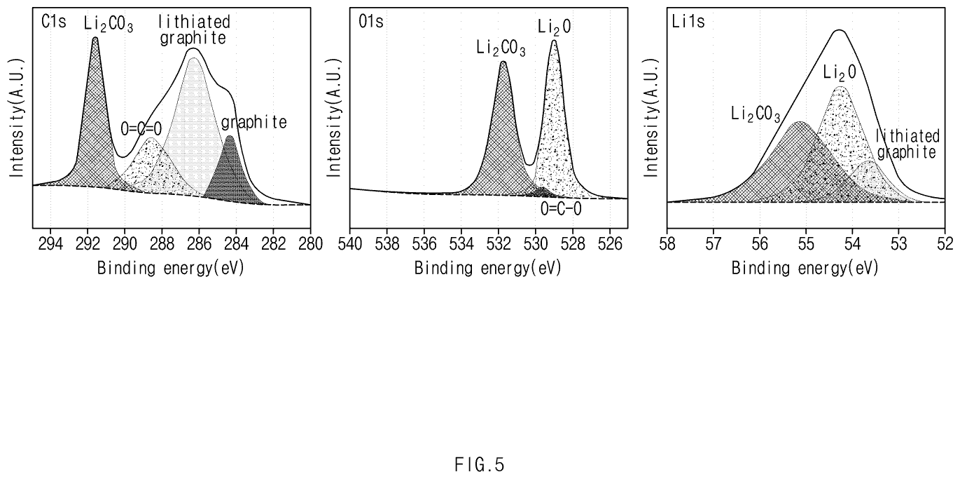

In addition, an XPS analysis was performed with respect to an opposite surface to a contact surface between the intermediate layer and the solid electrolyte layer after separating the intermediate layer without separately applying a current to the anodeless all-solid-state battery according to Embodiment 1, thereby obtaining a C1s spectrum and a O1s spectrum, and the C1s spectrum and the O1s spectrum are illustrated in FIG. 4. In addition, the XPS analysis was performed with respect to the opposite surface to a contact surface between the intermediate layer and the solid electrolyte layer after depositing lithium having the capacity of 2.0 mAh/cm² on the intermediate layer and separating the intermediate layer, in the anodeless all-solid-state battery according to Embodiment 1, thereby obtaining a C1s spectrum, an O1s spectrum, and a Li1s spectrum, and the C1s spectrum, the O1s spectrum, and the Li1s spectrum are illustrated in FIG. 5. The above XPS analysis was performed using a spectrometer (Thermo Scientific; K-Alpha+; acceleration voltage: 100 eV to 4,000 eV; maximum resolution: 0.50 eV).

Referring to FIG. 3, it may be recognized that the base body included in the layered carbon material forming the intermediate layer according to Embodiment 1 was swollen during charging. Referring to FIGS. 4 and 5, it may be recognized that LiC₆ is formed in the base body, when the base body included in the layered carbon material forming the intermediate layer according to Embodiment 1 was swollen.

### Observation of Structure of Separation Space Between Base Bodies

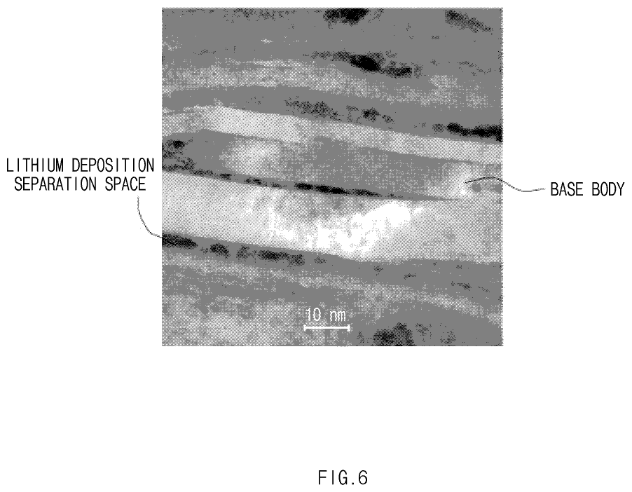

After fully charging the anodeless all-solid-state battery according to Embodiment 1, the intermediate layer was separated, and a STEM image was obtained with respect to the separated intermediate layer, using STEM equipment (Titan cupped G2) under the condition of an accelerating voltage of 300 kV. The obtained STEM image is illustrated in FIG. 6.

### Experimental Example 2—Comparison Between Embodiment 1 and Comparative Example 1

Manufacturing Anodeless all-Solid-State Battery

For each electrode for an all-solid-state battery manufactured in Embodiment 1 and Comparative example 1, 150 to 200 mg of sulfide-based solid electrolyte (Li₆PS₅Cl_{0.5}Br_{0.5}) powders were filled in an annular mold having the diameter of 13 mm, and the result was pressed under the pressure of 400 MPa to place a solid electrolyte layer. Then, the result was pressed under the pressure of 100 MPa, thereby forming an intermediate layer having a thickness of 10 μm between the solid electrolyte layer and the anode current collector.

Thereafter, 20 mg of mixed powders, which are obtained by mixing a cathode active material (LiNi_{0.8}Co_{0.1}Mn_{0.1}O₂), a solid electrolyte (Li₆PS₅Cl_{0.5}Br_{0.5}), a binder (VGCF) at the ratio of 70:30:3, were placed on the opposite surface of the solid electrolyte layer, and the result structure was compressed at 200 MPa, thereby forming a cathode active material layer. Then, the cathode current collector including Al and having the thickness of 10 μm was provided to meet the cathode active material layer, and the result structure was compressed at 380 MPa, thereby manufacturing the anodeless all-solid-state battery.

### Comparison 1 of the Structure of Carbon Structure

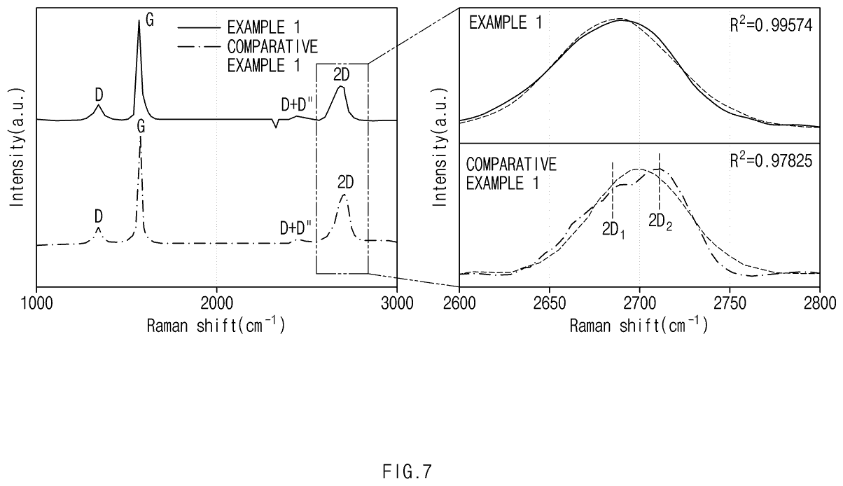

A Raman spectrum was obtained through the measurement of a Raman spectroscopy (XperRF; Nanobase using 532 nm laser) for each intermediate layer of the anodeless all-solid-state battery according to Embodiment 1 and the anodeless all-solid-state battery according to Comparative example 1, and is illustrated in FIG. 7. In addition, a 2D peak of each of Embodiment 1 and Comparative example 1 observed in the Raman 2,600/cm to 2,800/cm was fitted with a single Voigt profile (point curve), and each coefficient of determination (R²) was calculated using the 2D peak.

Referring to FIG. 7, it may be recognized that one peak was observed in Embodiment 1, and the coefficient of determination (R²) was 0.99574, and, two peaks (2D₁, 2D₂) were observed in Comparative example 1 and the coefficient of determination (R²) was 0.97825, in the Raman shift range from 2, 600/cm to 2,800/cm. Accordingly, it may be recognized that the intermediate layer according to Embodiment 1 has a structure similar to a structure of graphene having a thin thickness, which is different from the intermediate layer of Comparative example 1.

### Comparison 2 of Carbon Structure

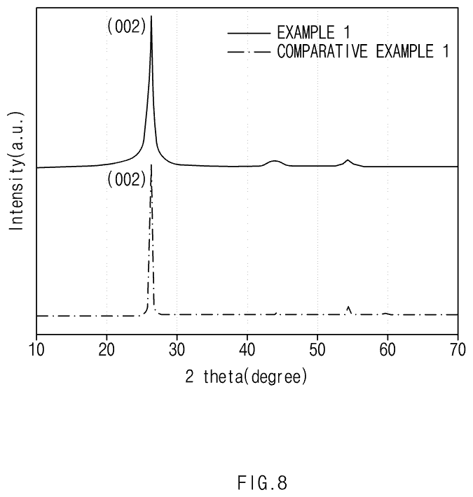

For each of the intermediate layer in the anodeless all-solid-state battery according to Embodiment 1 and the intermediate layer in the anodeless all-solid-state battery according to Comparative example 1, an XRD spectrum was obtained using Miniflex (Rigaku), through measurement with the voltage of 40 kV, the current mA Cuka, 2θ (brag angle) ranging from 10° to 70°, and a scan speed=2°/60 sec, and is illustrated in FIG. 8.

Referring to FIG. 8, it may be recognized that the FWHM of the (002) peak observed around 24° to 30° was measured using the XRD spectrum, and the measurement result was 0.528° in Embodiment 1 and 0.264° in Comparative example 1. Accordingly, it may be recognized that the intermediate layer according to Embodiment 1 has a narrow gap formed therein, which is different form the intermediate layer of Comparative example 1. The gap is recognized as a separation space between base bodies which are included in the layered carbon material.

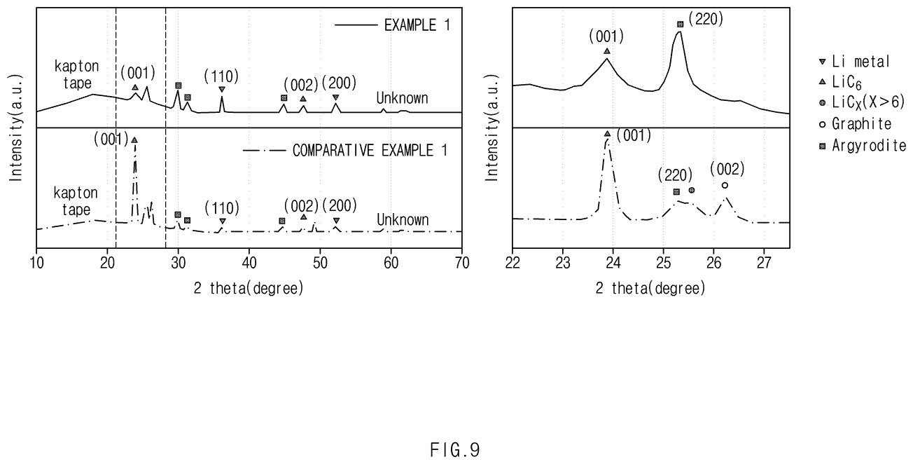

For each of the intermediate layer in the anodeless all-solid-state battery according to Embodiment 1 and the intermediate layer in the anodeless all-solid-state battery according to Comparative example 1, after depositing lithium having the capacity of 2.0 mAh/cm² on each intermediate layer using the current density of 0.5 mA/cm², and separating the intermediate layer, an XRD spectrum was obtained with respect to the opposite surface to a contact surface between the intermediate layer and the solid electrolyte layer using Miniflex (Rigaku), through measurement with the voltage of 40 kV, the current 15 mA, Cuka, 2θ (brag angle) ranging from 10° to 70°, and a scan speed=2°/60 sec, and is illustrated in FIG. 9.

The XRD spectrum of FIG. 9 was analyzed, and when the intensity of a LiC₆ (001) peak of the anodeless all-solid-state battery according to Embodiment 1 was set to ‘1’, the relative intensities of a Li (110) peak, a graphite (001) peak, and a LiCₓ (x>6) peak of the anodeless all-solid-state battery according to Embodiment 1 to the intensity of the LiC₆ (001) peak of the anodeless all-solid-state battery according to Embodiment 1 were shown in following Table 1. In addition, when the intensity of a LiC₆ (001) peak of the anodeless all-solid-state battery according to Comparative example 1 was set to ‘1’, the relative intensities of a Li (110) peak, a graphite (001) peak, and a LiCₓ (x>6) peak of the anodeless all-solid-state battery according to Comparative example 1 to the intensity of the LiC₆ (001) peak of the anodeless all-solid-state battery were shown in Table 1.

TABLE 1

| | LIC₆ | Li | graphite | LiCₓ |
|---|---|---|---|---|
| | (001) | (110) | (001) | (x > 6) |
| Embodiment 1 | 1 | 1.02 | 0 | 0 |
| Comparative | 1 | 0.08 | 0.23 | 0.51 |
| example 1 | | | | |

Referring to FIG. 9 and Table 1, it may be recognized that although carbon incompletely reacted with lithium, and carbon (graphite (001)), which was not completely reacted with (LiCₓ, x>6) lithium, were not detected on the XRD after the lithium deposition according to Embodiment 1, but it may be recognized that carbon (graphite), which was not reacted with (LiCₓ, x>6), was detected on the XRD according to Comparative example 1.

In addition, according to Embodiment 1, it may be recognized that the relative intensity of the Li (110) peak was expressed as ‘1.02’, as compared to the LiCₓ, (001) peak, even though the XRD measurement was performed with respect to the opposite surface to the contact surface between the intermediate layer and the solid electrolyte layer. Accordingly, it may be recognized that lithium is precipitated between the base body and the base body inside the intermediate layer.

### Evaluation for Diffusion Behavior of Lithium Ion

For each of electrodes for the anodeless all-solid-state battery manufactured in Embodiment 1 and Comparative example 1, 150 to 200 mg of a sulfide-based solid electrolyte (Li₆PS₅Cl_{0.5}Br_{0.5}) powder was filled in an annular mold having a diameter of 13 mm, and pressed under a pressure of 400 MPa to place the solid electrolyte layer. Then, the result structure was pressed under the pressure of 100 MPa, thereby forming an intermediate layer having a thickness of 10 μm between the solid electrolyte layer and the anode current collector.

Thereafter, a lithium metal foil having the thickness of 200 μm and punched with the diameter of 12 mm was inserted into the opposite surface of the solid electrolyte layer. Thereafter, a T-shaped member serving as a lid was inserted into the annular mold in an up and down direction and sealed. Next, the annular mold was fastened under the fastening pressure of 3 Nm torque using a pressure jig, thereby manufacturing a half-cell.

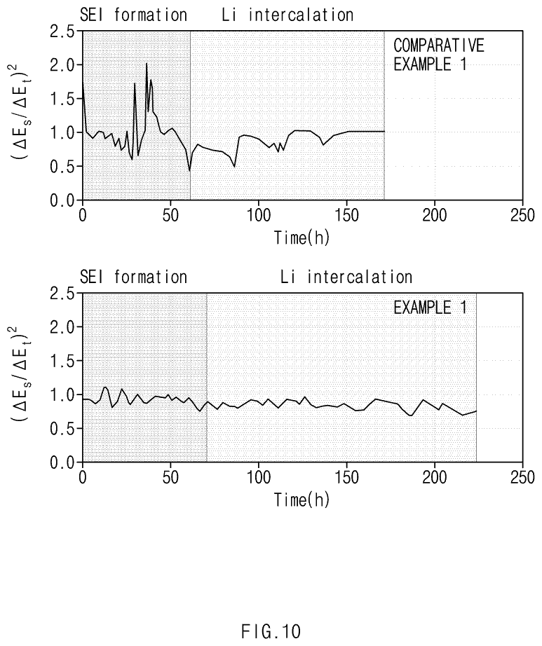

Galvanostatic Intermittent Mitigation Technique (GITT) measurement for the first discharge process was performed with respect to of half-cells according to Embodiment 1 and Comparative example 1 (electrode loading amount is 0.9 mg/cm², in each half-cell) by applying a current of 17.5 mA/g for 20 minutes, and stopping applying the current for 40 minutes, under the condition of a room temperature (25° C.) and driving pressure of 30 MPa. FIG. 10 illustrates a graph illustrating the square ((ΔEₛ/ΔEₜ)²) of the ratio of a voltage change (ΔEₛ) during stopping the application of the current to a voltage change (ΔEₜ) during the application of a current, over a progress time (h) of GITT for the intermediate layer of each of the half-cells according to Embodiment 1 and Comparative example 1.

Referring to FIG. 10, it may be recognized that the (ΔEₛ/ΔEₜ) 2 value according to Embodiment 1 was constantly maintained over the process time of GITT, and that (ΔEₛ/ΔEₜ) 2 value according to Comparative example 1 was rapidly reduced at 61 h, 87 h, 115 h, and 137 h. Accordingly, it may be recognized, based on the (ΔEₛ/ΔEₜ) 2 value proportional to the diffusion coefficient, that Embodiment 1 including the layered carbon material more stably diffuses lithium ions, as compared to Comparative example 1 including graphite.

### Evaluation for Cycle Characteristics

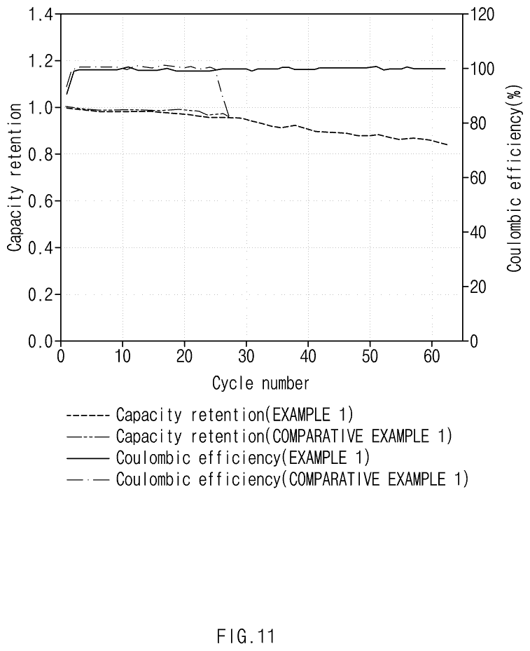

For each of the anodeless all-solid-state batteries according to Embodiment 1 and Comparative example 1, when a charging operation is performed until 4.2 V at the current density of 2.52 mA/cm² and a discharging operation is performed until 2.8 V at the current density of 2.52 mA/cm² under the condition of a room temperature and the pressure of 15 MPa, in one cycle, the charging operation and the discharging operation were repeated to 60th cycle under the above charging and discharging condition, a capacity retention rate and Coulombic efficiency per cycle were measured, and the measurement result is illustrated in the form of a graph of FIG. 11.

Referring to FIG. 11, it may be recognized which the anodeless all-solid-state battery according to Comparative example 1 was stopped due to an internal short circuit in 26 cycles, but the anodeless all-solid-state battery according to Embodiment 1 was stably driven in 60 cycles or more. It is expected that lithium was stably deposited inside the intermediate layer without being grown in a dendrite form through an internal lithium growth mechanism, thereby improving the cycle characteristic.

### Experimental Example 3

### Measurement of Particle Size Distribution

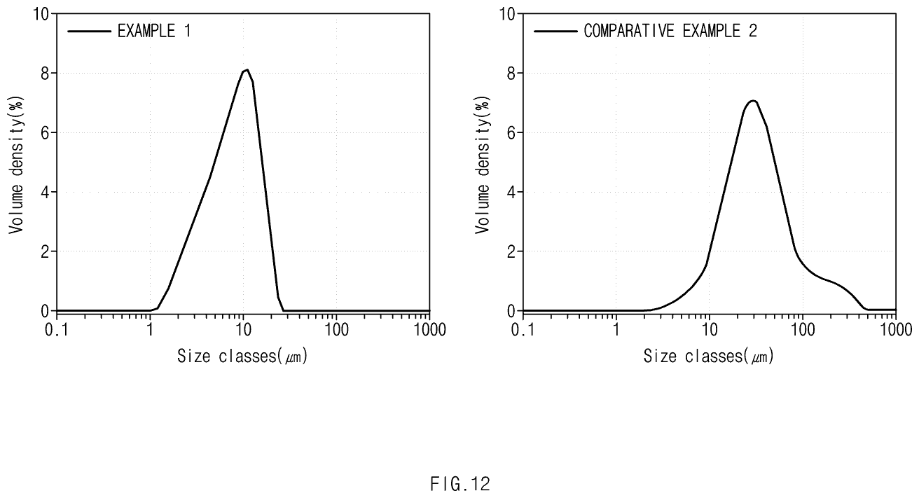

After dispersing, in acetone, 1 g of carbon structure powders prepared according to each of Embodiment 1 and Comparative example 2, a particle size distribution of the carbon structure powders prepared was measured through a particle size analyzer (product name: Mastersizer 3000, Malvern Panalytic). The graph of the particle size distribution is illustrated in FIG. 12, and values of D₁₀, D₅₀, D₉₀, and SPAN ((D₉₀−D₁₀)/D₅₀) specified in the graph of the particle size distribution of FIG. 12 are shown in Table 2.

The particle size distribution was measured under conditions of Max. 4 mW He—Ne 632.8 nm as a red light source, and Max. 10 mW LED 470 nm as a blue light source.

TABLE 2

| | D₁₀ (μm) | D₅₀ (μm) | D₉₀ (μm) | SPAN |
|---|---|---|---|---|
| Embodiment 1 | 3.12 | 8.63 | 17 | 1.61 |
| comparative | 13.1 | 33.0 | 110 | 2.94 |
| example 2 | | | | |

### Manufacturing and Evaluating Half-cell

For the electrode for each of electrodes for the all-solid-state batteries manufactured in Embodiment 1 and Comparative example 2, 150 to 200 mg of a sulfide-based solid electrolyte (Li₆PS₅Cl_{0.5}Br_{0.5}) powder was filled in an annular mold having a diameter of 13 mm, and pressed under a pressure of 400 MPa to place the solid electrolyte layer. Then, the result structure was pressed under the pressure of 100 MPa, thereby forming an intermediate layer having a thickness of 10 μm between the solid electrolyte layer and the anode current collector.

Thereafter, a lithium metal foil having a thickness of 200 μm punched with a diameter of 12 mm was inserted into the opposite surface of the solid electrolyte layer above, and then a T-shaped member serving as a lid was inserted and sealed in the upper and lower directions of the annular mold. Next, the annular mold was fastened under the fastening pressure of 3 Nm torque using a pressure jig, thereby manufacturing a half-cell.

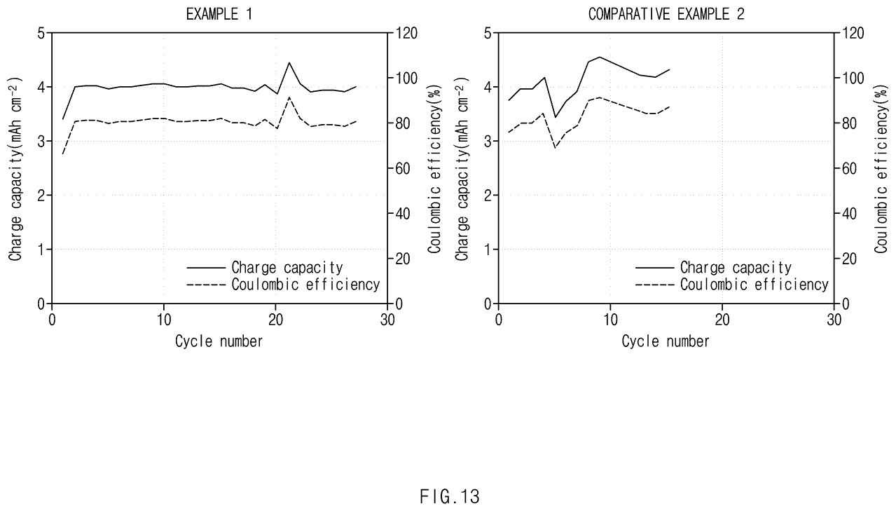

For each of half-cells according to Embodiment 1 and Comparative example 2, when lithium having the capacity of 3.5 mA/cm² is deposited at the current density of 1.167 mA/cm² and is stripped at the current density of 1.167 mA/cm², under the condition of the temperature of 25° C. and the pressure of 20 MPa, in one cycle, the charging operation and the discharging operation were repeated to 28-th cycle, a Coulombic efficiency and a charging capacity were measured per cycle, and the measurement result is illustrated in the form of a graph of FIG. 13.

Referring to FIGS. 12 and 13, it may be recognized that driving was stably performed without a short circuit even in a high capacity supported environment of 3.5 mAh/cm² for Embodiment 1. It may be recognized that a short circuit occurred in 15-th cycle for Comparative example 2.

This is determined that, as a carbon structure failed to satisfy a desirable particle condition of a base body was employed as an intermediate layer according to Comparative example 2, the lithium deposition separation space formed between the base bodies was more reduced, as compared to Embodiment 1, to prevent the lithium deposition mechanism described with reference to FIG. 1 from being performed, such that a lithium layer is additionally precipitated between the intermediate layer and the solid state layer.

As described above, according to an embodiment of the present disclosure, the electrode for the all-solid-state battery may prevent the lithium dendrite growth to precipitate lithium only in the electrode without being precipitated in the form of the additional layer.

According to an embodiment of the present disclosure, the anodeless all-solid-state battery includes the electrode for the all-solid-state battery, to prevent the lithium from making direct contact with the solid electrolyte, thereby exhibiting the excellent lifespan characteristic and the excellent battery characteristic.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. An electrode for an all-solid-state battery, the electrode comprising:
a current collector; and
an intermediate layer including a carbon structure and disposed on the current collector,
wherein the carbon structure includes a plurality of base bodies arranged with separation spaces formed between adjacent base bodies among the plurality of base bodies,
wherein the separation spaces include a lithium deposition separation space having a width in a range of 0.3 nm to 10 nm, and
wherein a diameter (D₅₀) corresponding to 50% of a cumulative volume in a cumulative volume distribution of a base body of the plurality of base bodies is in a range of 5 μm to 12 μm.

2. The electrode of claim 1, wherein a diameter (D₁₀) corresponding to 10% of the cumulative volume in the cumulative volume distribution of the base body is in a range of 1.5 μm to 4.5 μm.

3. The electrode of claim 1, wherein a diameter (D₉₀) corresponding to 90% of the cumulative volume in the cumulative volume distribution of the base body is in a range of 13 μm to 25 μm.

4. The electrode of claim 1, wherein the base body has a SPAN value of at most 1.9 based on Equation 1 below:
$$SPAN = \frac{{D}_{90} - {D}_{10}}{{D}_{50}} , \qquad Equation 1$$
wherein D₁₀ is a diameter (D₁₀) corresponding to 10% of the cumulative volume, in the cumulative volume distribution of the base body,
D₅₀ is a diameter (D₅₀) corresponding to 50% of the cumulative volume, in the cumulative volume distribution of the base body, and
D₉₀ is a diameter (D₉₀) corresponding to 90% of the cumulative volume, in the cumulative volume distribution of the base body.

5. The electrode of claim 1, wherein the plurality of base bodies are stacked and spaced apart from each other along a stack direction.

6. The electrode of claim 1, wherein, based on a total number of separation spaces, a proportion of the total number of separation spaces includes at least 45% of the lithium deposition separation space.

7. The electrode of claim 1, wherein the lithium deposition separation space has a width in a range of 2 nm to 8 nm.

8. The electrode of claim 1, wherein a particle size of the base body in a (002) direction ranges from 5 nm to 30 nm.

9. The electrode of claim 1, wherein the intermediate layer includes the carbon structure in a content in a range of 85 wt % to 97.5 wt %.

10. The electrode of claim 1, wherein the intermediate layer includes the carbon structure having a density in a range of 0.8 g/cm³ to 2.0 g/cm³.

11. An anodeless all-solid-state battery comprising:
an anode current collector;
an intermediate layer including a carbon structure and disposed on the anode current collector;
a solid electrolyte layer disposed on the intermediate layer;
a cathode active material layer including a cathode active material and disposed on the solid electrolyte layer; and
a cathode current collector disposed on the cathode active material layer,
wherein the carbon structure includes:
a plurality of base bodies arranged with separation spaces formed between adjacent base bodies among the plurality of base bodies,
wherein the separation spaces include a lithium deposition separation space having a width in a range of 0.3 nm to 10 nm, and
wherein a diameter (D₅₀) corresponding to 50% of a cumulative volume in a cumulative volume distribution of a base body of the plurality of base bodies is in a range of 5 μm to 12 μm.

12. The anodeless all-solid-state battery of claim 11, wherein the intermediate layer has a thickness in a range of 5 μm to 20 μm, before the anodeless all-solid-state battery is driven.

13. The anodeless all-solid-state battery of claim 11, wherein a lithium ion is deposited in the lithium deposition separation space, when the anodeless all-solid-state battery is charged.

14. The anodeless all-solid-state battery of claim 11, wherein an additional lithium deposition layer is not formed between the intermediate layer and the solid electrolyte layer, when the anodeless all-solid-state battery is charged.

15. The anodeless all-solid-state battery of claim 11, wherein a ratio of an intensity of a Li peak to an intensity of a LiC₆ peak is at least 0.5, when an XRD analysis is analyzed with respect to the intermediate layer, after the anodeless all-solid-state battery is fully charged.

16. The anodeless all-solid-state battery of claim 11, wherein the solid electrolyte layer includes a sulfide-based solid electrolyte.

17. A method for manufacturing an electrode for an anodeless all-solid-state battery, the method comprising:
separating a base body from a carbon material by applying energy to a mixture solution in which the carbon material and a polymer binder are solved, and rearranging a result structure through self-assembling; and
preparing a carbon structure by ball-mill grinding the result structure in a range of 55 minutes to 150 minutes.

18. The method of claim 17, further comprising:
forming a separation space by removing the polymer binder from the mixture solution, as energy is applied to the mixture solution.

19. The method of claim 17, wherein the polymer binder includes polyester, polyethylene vinyl acetate, polyester-polyethylene vinyl acetate copolymer, polyvinyl chloride, polyethylene, polypropylene, polybutadiene, polyolefin, polyvinyl chloride, polyvinyl acetate, polyethylene terephthalate, polystyrene, polyethylene ketone, polyethylene terephthalate glycol, polyethyleneimide, polyvinylidene fluoride, polytetrafluoroethylene, ethylene tetrafluoride, vinylidene fluoride-based copolymer, hexafluoropropylene, vinylidene fluoride/hexafluoropropylene copolymer, polyvinylidene fluoride, polyacrylonitrile, polymethyl methacrylate, polyimide, polyamide imide, polyacrylic acid, polyvinyl alcohol, styrene butadiene rubber polymer, acrylonitrile-butadiene rubber, acrylonitrile-butadiene-styrene rubber, acrylate rubber, hydroxypropylmethylcellulose, sodium carboxymethylcellulose, a composite polymer including at least one material of the above materials, or any combination thereof.

20. The method of claim 17, wherein the ball-mill grinding is performed in a range of 80 minutes to 120 minutes.
